(19) United States
(12) Patent Application Publication
(10) Pub. No.: US 2009/0208612 A1
(43) Pub. Date: Aug. 20, 2009

(54) Meat Analog Product

(75) Inventors: Ralf Reiser, Franklin, TN (US); Vinod Gumudavelli, Antioch, TN (US); William Gharibian, Smyrna, TN (US); Lewis James, Union Star, MO (US); Lucio Hiroshi Yonemoto, Franklin, TN (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: MARS, INCORPORATED, McLean, VA (US)

(21) Appl. No.: 12/370,314

(22) Filed: Feb. 12, 2009

Related U.S. Application Data
(60) Provisional application No. 61/027,960, filed on Feb. 12, 2008.

(51) Int. Cl. A23J 3/22; A23L 1/317

(52) U.S. Cl. 426/104; 426/72; 426/74; 426/516; 426/442

(57) ABSTRACT

A meat analog product is provided prepared starting from a dry component that is a combination of ingredients, including a dry sulfur protein source, a carbohydrate source, a liquid, and a monovalent cationic bicarbonate or carbonate. The meat analog product can be produced and extruded under low shear conditions to provide a product having a plurality of striated and separable aligned fibers and a real meat appearance.

### CROSS-REFERENCE TO RELATED APPLICATIONS

This application claims the benefit of the filing date of U.S. Provisional Application Ser. No. 61/027,960, filed 12 Feb. 2008 which is hereby incorporated by reference in its entirety.

### FIELD OF THE INVENTION

This invention relates to processes for preparing a meat analog product having a meat-like appearance and texture comprising a plurality of separable and striated aligned fibers and the products so produced.

### BACKGROUND OF THE INVENTION

The conventional production of meat analogs consists of two main stages: emulsion preparation and formation of a chunk. An emulsion is typically prepared by mixing, chopping and emulsifying proteins, salts, fat and other inclusions to form a matrix of proteins that encapsulates the fat and the non-soluble inclusions. The emulsion is then heated under pressure that is aimed in a specific direction. The pressure arranges and orients protein chains and helps a three-dimensional network to be formed. The heat denatures the proteins and sets the matrix irreversibly so the final chunk product retains its shape.

Conventional emulsion preparation is disadvantageous in that it involves many process steps, requires significant amounts of equipment, and is usually labor intensive. The process steps include flaking and breaking frozen meat, grinding meat and additional lean meat and/or fat, blending dry powdered components, mixing the dry components with the wet components, warming to mix or thaw the frozen meat, emulsify the mix, and pumping it to the chunk forming device. Some of the equipment required for this process are freezers, grinders, mixers, pumps, and refrigerated trucks. Such a process is described, for example, in U.S. Pat. No. 4,781,939.

Another limitation in conventional methods for preparing meat analogs from meat emulsions is inconsistent repeatable composition, due to the inconsistent composition of the raw ingredients, mainly frozen blocks of beef, chicken, and other co-products of the meat industry. Meat is a natural product that contains a wide range of fat, proteins, carbohydrates and levels of minor nutrients. For example, mechanically deboned meat can contain protein levels from 5-20 wt % and fat levels from 5-50 wt % (see, for example, Field et al., J. Anim. Sci. 1976, 43, 755)

Many meat analog recipes include sulfate in the form of elemental sulfur, potassium sulfide and sodium sulfide, as described for example in U.S. Pat. No. 3,496,858. The sulfate improves the texture of the chunk since it permits cross-linking between proteins due to intermolecular disulfide bond formation. On the other hand, the advantages provided by sulfate compounds in producing realistic looking meat chunks is counterbalanced by its negative effects on the taste and aroma of the meat analog product.

U.S. Pat. No. 3,962,481 describes the preparation of a textured protein product utilizing a method comprising preparing an alkaline slurry of a protein source followed by precipitation of the product by changing the pH and temperature of the slurry. However, while the method provides a product having a meat-like texture, the method does not provide a product having a real meat like appearance comprising a plurality of striated and separable aligned fibers.

U.S. Pat. No. 6,379,738 describes the preparation of a meat emulsion product with realistic fiber definition utilizing a method comprising preparing a meat emulsion by mixing, chopping and emulsifying a mixture of raw meat materials in a manner to produce a meat emulsion that contains fine fat particles coated with protein dissolved from meat ingredients. However, such methods are labor intensive and can result in an inconsistent end product depending on the nature of the raw meats available for use.

WO 97/11610 describes the preparation of leavened foodstuffs having a spongy internal texture via formation of a leavened and gelled mixture. However, the process does not produce a foodstuff having a real meat-like appearance comprising a plurality of striated and separable aligned fibers; rather the product is a solid chunk having a surface texture comprising “wrinkle-like” features.

Thus, there continues to exist a need in the art to develop processes for producing meat analogs having a real meat like appearance and texture in a controlled manner without using non-palatable texturization agents.

### SUMMARY OF THE INVENTION

This invention provides processes for making meat analogs having a real meat-like appearance comprising a plurality of striated and separable aligned fibers, and the meat analog products produced using such processes, wherein the protein ingredients comprise dry protein ingredients, instead of a conventional meat emulsion.

In a first aspect, the invention provides a meat analog product comprising a combination of a dry component, a liquid, and a monovalent cationic carbonate or bicarbonate source (MVCBC), wherein the dry component, having a protein content, comprises a dry sulfur protein source, the liquid comprises water; and the meat analog product comprises a plurality of striated and separable aligned fibers throughout the product.

In a second aspect, the invention provides methods for preparing a meat analog product, comprising: combining a monovalent cationic bicarbonate or carbonate source, water, and a dry component comprising a dry sulfur protein source under low shear mixing conditions to form a dough; heating the dough to a temperature of about 100-150° C. to yield a heated dough; providing the heated dough to an entry orifice of a cooling device; and conveying the heated dough through the cooling device under a pressure of 50-900 psi to an exit orifice of the cooling device to yield a meat analog product, wherein the meat analog product has a processing temperature of 100° C. or less at the exit orifice.

In a third aspect, the invention provides a meat analog product prepared according to the methods of the second aspects of the invention.

In certain embodiments of the preceding aspects, the meat analog product can further comprise a reducing agent as set forth herein, including but not limited to inactivated yeast, which can be present in either or both of the dry component and the liquid.

Specific preferred embodiments of the present invention will become evident from the following more detailed description of certain preferred embodiments and the claims.

### BRIEF DESCRIPTION OF THE DRAWINGS

FIG. 1 shows a diced meat analog product according to an embodiment of the present invention.

FIG. 2 shows a diced and shredded meat analog product according to an embodiment of the present invention in combination with vegetables for contrast.

### DETAILED DESCRIPTION OF THE INVENTION

The invention provides meat analog products in the form of distinct chunks or pieces, comprising manually separable meat-like aligned fibers resembling a piece of natural meat in appearance, texture, and consistency, and methods for producing said meat analog products. The meat chunks of this invention are suitable for use as a partial or complete replacement for more expensive natural meat chunks in both human foods and animal foods, and retain their integrity and shape when subjected to commercial canning and sterilization procedures such as those required in the production of shelf stable high moisture food products

The term “dry” as used herein means that the referenced item contains less than about 15 wt. % water; preferably, the referenced item contains less than about 10 wt. % water.

The term “meat meal” as used herein refers to the rendered product from animal tissues, including bone, exclusive of any added blood, hair, hoof, horn, hide trimmings, manure, stomach and rumen contents, except in such amounts as can occur unavoidably in good processing practices. Meat meal can be in the form of, for example, beef meal, chicken meal, fish meal (e.g., salmon meal), meals produced from other animals, and mixtures thereof.

The term “gluten” as used herein refers to the purified protein product yielded from the purification of the stored proteins in the endosperms of grains, such as wheat, oats, corn, rice, rye, and barley, and mixtures thereof, by washing away the associated starch. Typically, gluten comprises gliadin in a mixture with glutenin.

The term “meat by-product” as used herein means the non-rendered clean parts, other than meat, derived from slaughtered mammals. “Meat-by-products” include, but are not limited to, organs including lungs, spleen, kidney, liver, and particularly stomachs and intestines freed of their contents; blood; and partially defatted low temperature fatty tissue. Meat by-products do not include hair, horns, teeth, and hoofs.

The term “monovalent cationic bicarbonate or carbonate source” as used herein means one or more chemical compounds formed between a carbonate or bicarbonate anion and a monovalent cation (e.g., sodium, potassium, and ammonium). Such sources include, but are not limited to, sodium bicarbonate, ammonium bicarbonate, potassium bicarbonate, sodium carbonate, potassium carbonate, and ammonium carbonate.

The term “reducing agent” as used herein means one or more chemical compounds including L-cysteine, glutathione, bisulfite, nonleavening yeast, and/or inactivated yeast.

The term “leavening acid” refers to an agent that can react with moisture, heat, acidity, or other triggers to produce an acid. Examples of leavening acids include, but are not limited to, potassium bitartarate, monocalcium phosphate, dicalcium phosphate, calcium aluminum phosphate, sodium aluminum phosphate, potassium aluminum phosphate, sodium pyrophosphate, sodium aluminum sulfate; potassium aluminum sulfate; ammonium alums; sodium alums; potassium alums; monosodium phosphate; monopotassium phosphate; tartaric acid; citric acid; adipic acid; fumaric acid; monosodium dihydrogen phosphate; dicalcium phosphate, monoammonium phosphate; monopotassium tartrate; and glucono-delta-lactone.

The term “striated” as used herein means the referenced object is marked with grooves, scratches, or channels, particularly in an approximately parallel series.

The term “separable” as used herein means the referenced items can be readily broken apart by hand utilizing, for example, a fork or bare hands. Included in this definition are striated meat analog products, wherein the striations provide easily-separated fracture planes that are easily dissociated to produce a separated or broken-up meat analog product.

The term “orifice” as used herein means the one or more apertures present at the end of a device, such as a cooling device, through which the meat analog product of the invention is conveyed.

The term “sulfur protein source” as used herein means a food grade proteinaceous material derived from any animal, vegetable, nut or fruit source comprising one or more cysteine and/or cystine residues. For example, sulfur protein sources include but are not limited to raw or frozen meat, eggs, whey, meat meals (e.g., chicken meal, beef meal), meat by-product meals (e.g., beef liver meal), and vegetable protein sources (e.g., glutens, soy, oats, and/or corn proteins).

The term “meat protein source” as used herein means a food grade proteinaceous material derived from any animal source. For example, protein sources include but are not limited to raw or frozen meat (e.g., chicken, beef, pork, seafood, lamb, venison, duck, buffalo), meat meals (e.g., chicken meal, beef meal), meat by-product meals (e.g., beef liver meal, chicken liver meal), and mechanically deboned meat.

The term “palatant” as used herein refers to one or more compounds or compositions known to those skilled in the art to increase the feeding response of an animal, including any known or commercially available liquid or dry palatant enhancers commercially available from pet food palatant enhancer or other flavor suppliers known to those of skill in the art, such as GOTAste™ and SAVORATE™. Additional examples include, but are not limited to, lysine, phenylalanine, tyrosine, tryptophan, methionine, arginine, isoleucine, leucine, and serine.

The term “pH” as used herein refers to the pH of a meat analog product as it exits a cooling device and otherwise has its conventional meaning in the art.

The term “processing temperature” as used herein refers to the temperature of a product as it exits a cooling device.

The term “protein content” as used herein refers to the percentage, by weight, of all the proteinaceous components of the referenced item.

The term “fat source” as used herein refers to any food grade material comprising greater than 80 wt % of one or more fats. Examples of fat sources include, but are not limited to, beef fat, chicken fat, sunflower oil, vegetable, seed, nut, and fish oil. Such fat sources can be liquids when introduced with the liquid and can be solid when introduced with the dry component(s).

The term “coloring agent” as used herein refers to any food grade compound or composition that imparts a color change to the matrix to which it is added. Examples of coloring agents include, but are not limited to, caramel, iron oxide, red blood cells, and other organic or inorganic dye or pigments such as turmeric, riboflavin, quinoline yellow, sunset yellow FCF, carminic acid, allura red AC, brilliant blue FCF, chlorophyll, green S, fast green FCF, caramels, brilliant black BN or brilliant black PN, brown HT, carotene, annatto extracts, lycopene, beet red, anthocyanins or grape skin extract or blackcurrant extract, titanium dioxide, iron oxide, tannic acid, and tannins.

The term “fiber source” as used herein means one or more fibers derived from fruits, vegetables, grains, nuts, and seeds. Examples include, but are not limited to fibers derived from legumes (peas, soybeans, and other beans), oats, corn, rye, and barley, fruits such as apples, plums, and berries (e.g., strawberries, raspberries, and blackberries), and vegetables such as broccoli, carrots, green beans, cauliflower, zucchini, celery, potatoes, sweet potatoes, psyllium seed husk, oat bran, wheat bran and beet pulp, cellulose, sugar cane based fibers.

The term “food grade” as used herein refers to any compound or composition suitable for human and/or animal consumption.

The term “seafood meat” as used herein refers to meat derived from fish, crustacea, and other aquatic animals. For example, seafood meat includes, but is not limited to salmon, catfish, whitefish, crab, and the like. Seafood meat further includes meat meals prepared from seafood sources, for example, salmon meal and catfish meal.

The term “humectant” as used herein refers to one or more materials capable of increasing water retention in a product. Examples of humectants include, but are not limited to, sodium lactate, potassium lactate, sodium malates, sorbitol, sorbitol syrup, mannitol, glycerin or glycerol, isomalt, maltitol, maltitol syrup, hydrogenated glucose syrup, lactitol, xylitol, erythritol, polydextrose, triacetin, and propylene glycol.

The term “antioxidant” as used herein refers to one or more compounds including vitamin C (e.g., ascorbic acid, methyl ascorbate, sodium ascorbate), vitamin E (e.g., tocopherol, tocopherol acetate, tocotrieneols), carentoids, flavinoids, propyl gallate, butylated hydroxytoluene (BHT), t-butylhydroquinone (TBHQ), butylated hydroxyanisole (BHA), or an extract of a fruit or vegetable known to contain antioxidants, such as, but not limited to, vitamin C sources including kakadu plum, camu camu, rose hip, acerola, amla, seabuckthorn, jujube, baobab, black currant, red pepper, parsley, guava, kiwifruit, broccoli, loganberry, red currant, brussel sprouts, wolfberry (goji), lychee, cloudberry, persimmon, papaya, strawberry, orange, lemon, cantaloupe, cauliflower, grapefruit, raspberry, tangerine, passion fruit, spinach, cabbage, lime, mango, potato, honeydew, cranberry, tomato, blueberry, and pineapple; and vitamin E sources including wheat germ oil, sunflower oil, hazelnut, walnut oil, peanut oil, olive oil, peanut, pollard corn, asparagus, oats, chestnut, coconut, tomatoes, carrots, polyphenols, rosemary extract, catequins, and flavanol.

The term “starch” as used herein refers to one or more compositions derived from a grain, vegetable, or fruit source comprising starch. For example, arrowroot, tapioca, and starches derived from buckwheat, banana, barley, cassava, sorghum, potatoes, sweet potatoes, taro, yarns, fava beans, lentils, and peas.

The term “carbohydrate source” as used herein refers to a source of complex carbohydrates which provides for increased tack or stickiness in a dough comprising the same. Examples of carbohydrate sources include, but are not limited to, corn flour, sugar beet flour, corn meal, pea fibers, and starches, as defined herein.

The term “dough” as used herein refers to an intermediate food product that has a sulfur protein based structure. In a dough, the proteins form a continuous elastic dough medium into which other ingredients can be embedded.

The term “low shear conditions” as used herein, refers to conditions for preparing and/or conveying a dough which do not cause substantial physical cleaving or physical denaturization of proteins within the dough as a result of a stress or strain placed upon the dough. Examples of low shear mixers include, but are not limited to, hand mixers, dough mixers, paddle mixers, ribbon mixers and single and twin screw extruders operated under low shear conditions. Examples of low shear conveyers include pumps, pistons, and single or twin screw extruders operated under low shear conditions.

The term “liquid” as used herein means a food grade liquid such as, but not limited to, water which can comprise additional components, such as, but not limited to, humectants (e.g., propylene glycol), fats, and liquid flavors.

### Dry Component

Dry components for preparing the meat analog products of the invention comprise a sulfur protein source in a dry and/or powdered state. For example, the dry component can consist essentially of a dry sulfur protein source. Alternatively, the dry component can comprise a plurality of dry ingredients, including at least the dry sulfur protein source. Such a plurality of dry ingredients can be added to the process (infra) simultaneously via separate feeds, simultaneously as a single dry component, or sequentially from the same or separate feeds. In certain embodiments, the dry component contains all the protein present in the ultimate meat analog product.

The dry sulfur protein source can comprise one or more meat protein sources or one or more vegetable protein sources, or mixtures thereof. The dry sulfur protein source can be present in the dry component to provide about 30 to 80 wt % of the protein in the dry component. In some embodiments, the dry sulfur protein source is present in a range to provide about 35 to 48 wt % of the protein in the dry component. In other embodiments, the dry sulfur protein source is present in a range to provide about 42 to 48 wt % of the protein in the dry component.

Dry vegetable protein source can comprise a gluten, soy protein, pea protein, or mixtures thereof. The dry vegetable protein source can comprise one or more glutens derived from, for example, wheat, rye, oats, corn, and/or barley. In some embodiments, the gluten comprises a wheat gluten. The dry vegetable protein source can be present in the dry component to provide about 30 to 80 wt % of the protein in the dry component. In some embodiments, the dry vegetable protein source is present in a range to provide about 30 to 80 wt % of the protein in the dry component. In some embodiments, the dry vegetable protein source is present in a range to provide about 30 to 48 wt % of the protein in the dry component. In other embodiments, the dry vegetable protein source is present in a range to provide about 42 to 48 wt % of the protein in the dry component.

Dry meat protein sources can comprise one or more dry meat protein sources such as one or more poultry meat sources, beef meat sources, pork meat sources, lamb meat sources, seafood meat sources, eggs, and/or whey. Such dry meat protein sources include, but are not limited to, meat meals, such as chicken meal, beef meal, fish meal (e.g., salmon meal and catfish meal), and meat by-product meals, such as beef liver meal. The dry meat protein source can be present in the dry component in a range to provide from about 0 to 70 wt % of the protein in the dry component. In some embodiments, the dry meat protein source is present in the dry component in a range to provide from about 0 to 30 wt % of the protein in the dry component. In other embodiments, the dry meat protein source is present in the dry component in a range to provide from about 5 to 12 wt % of the protein in the dry component.

The dry component can optionally further comprise a carbohydrate source. Such carbohydrate sources include, but are not limited to corn flour, sugar beet flour, corn meal, pea fibers, starches, and mixtures thereof. In general, and without being bound by any one particular theory of operation, the carbohydrate source provides an increased tack or stickiness to a dough prepared from the dry component (with respect to a dough prepared in the absence of a carbohydrate source). The carbohydrate source can be present in the dry component in a range from about 5 to 60 wt % by weight of the dry component. In some embodiments, the carbohydrate source can be present in a range from about 10 to 25 wt %. In particular, corn flour can impart stickiness to a dough prepared from the dry component, particularly as it exits a cooling device (infra).

Any one of a number of additional dry ingredients can be included in the dry component of the invention. Further ingredients for the dry component include, but are not limited to, the monovalent cationic bicarbonate or carbonate source and/or a reducing agent, and one or more humectant, fat source, coloring agent, palatant, flavoring, vitamin, mineral, antioxidant, dried blood plasma, salt, dextrose, sorbitol, starch, soy proteins, gelatin, nitrates, phosphates, or fiber sources. The dry component can further comprise a protein source or a fiber source derived from a whole grain, a fruit, a vegetable, or mixtures thereof.

The dry component can be prepared according to any methods known to those skilled in the art for blending dry ingredients, e.g., mixing proteins, salts, fat and other inclusions together. Each of the dry ingredients, as necessary, can be ground or otherwise reduced in unit size as necessary to facilitate ingredient mixing. Preferably, the components are ground or milled to a size between about 50 to 2000 μm, preferably between about 100 to 350 μm.

The dry component can comprise about 30 to 85% more preferably 35-68% protein, by weight; preferably, the dry component comprises about 35-48% protein by weight. Fat sources can be included in the dry component at a level ranging from about 0-20% by weight. Preferably, the fat content of the mixture ranges from about 3-8% by weight. As the mixture is dry, moisture can be maintained in the mixture at about 5-15% by weight; preferably, the moisture content ranges from 6-8% by weight. Salt can also be added to the dry component mix in a range from about 0-5% salt; preferably, salt comprises about 1-3% of the dry component, by weight.

### Processes for Forming Meat Analog Products

To form meat analog products of the invention, the dry component is mixed with a liquid under low shear conditions to form a dough, in the presence of a monovalent cationic bicarbonate or carbonate source, as defined herein, such as sodium bicarbonate. In other embodiments, the dough is formed in the presence of a monovalent cationic bicarbonate or carbonate source and a reducing agent, such as inactivated yeast.

Appropriate monovalent cationic bicarbonate or carbonate sources include, but are not limited to, sodium bicarbonate, ammonium bicarbonate, potassium bicarbonate, sodium carbonate, potassium carbonate, and ammonium carbonate. In a preferred embodiment, the monovalent cationic bicarbonate or carbonate source comprises sodium bicarbonate or sodium carbonate; in general, sodium bicarbonate is preferred.

Appropriate reducing agents include, but are not limited to, L-cysteine, glutathione, bisulfite, nonleavening yeast, and/or inactivated yeast. In a preferred embodiment the reducing agents comprises inactivated yeast.

Low shear mixing conditions, as defined here, for the preparation of the dough can be affected in, for example, a twin or single screw extruder. Alternatively, the low shear mixing can be accomplished, for example, using a low-shear dough mixer.

The liquid generally comprises water; however the liquid can further comprise additives such as fat and/or coloring agents that can be dissolved or slurried with the water, depending on the nature of the particular additive, as are familiar to those skilled in the art. Additionally, the liquid can comprise one or more monovalent cationic bicarbonate or carbonate source, reducing agent, leavening acid, humectant, fat source, coloring agent, palatant, flavoring, vitamin, mineral, antioxidant, dried blood plasma, salt, dextrose, sorbitol, starch, soy proteins, gelatin, nitrates, phosphates, or fiber source. Any of the preceding can be dissolved in the liquid or slurried or suspended within the liquid.

The liquid can also comprise a fresh or frozen meat source, a rendered meat source, or mixtures thereof. The fresh, frozen, or rendered meat sources can comprise 0 to 40 wt % of the total dough weight. When utilized, the fresh, frozen, or rendered meat source can comprise 3 to 15 wt % of the total dough weight. When a fresh or frozen meat source, and/or a rendered meat source is utilized, the meat source can be blended into the liquid and provided as a single liquid or the meat source can be provided as a separate source which is provided with the liquid (i.e., a separate feed line which introduces the meat source essentially with the liquid).

In general, the liquid can be provided as a single source, such that any components other than water are blended prior to their introduction into the process. Alternatively, a plurality of the liquid components can be added to the process simultaneously via separate feeds or sequentially from the same or separate feeds.

The monovalent cationic bicarbonate or carbonate source can be contained within either the dry component (supra) or the liquid. When the dry component comprises the monovalent cationic bicarbonate or carbonate source, then the dry component can comprise 0.4-4.8 wt % or 0.8-2.4 wt % of the monovalent cationic bicarbonate or carbonate source. Preferably, the dry component comprises 1.0-1.5 wt % of the monovalent cationic bicarbonate or carbonate source.

When present, the reducing agent can be contained within either the dry component (supra) or the liquid. When the dry component comprises the reducing agent, then the dry component can comprise 0 to 5 wt %, more preferably 0.5-4 wt % of the reducing agent. Preferably, the dry component can comprise 0.5 to 3 wt % of the reducing agent.

In another embodiment, the dry component or liquid can further comprise a leavening acid, as defined herein. Appropriate leavening acids include, but are not limited to, potassium bitartarate, monocalcium phosphate, dicalcium phosphate, sodium citrate, calcium aluminum phosphate, tricalcium phosphate, sodium tripolyphosphate (STPP), sodium aluminum phosphate, sodium aluminum sulfate, sodium pyrophosphate, monopotassium tartrate and delta-gluconolactone. In a preferred embodiment, the leavening acid comprises dicalcium phosphate. When both the monovalent cationic bicarbonate or carbonate source and the leavening acid are present, they are present a ratio of about 1:2-1:4. Preferably, when the monovalent cationic bicarbonate or carbonate source and the leavening acid are present, they are present a ratio of about 1:3.

In a preferred embodiment, the dough is formed from the liquid and the dry component, wherein the liquid comprises water and the dry component comprises a sulfur protein source and a carbohydrate source. In another preferred embodiment, the dough is formed from the liquid and the dry component, wherein the liquid comprises water and the dry component comprises a sulfur protein source, a carbohydrate source, and the monovalent cationic bicarbonate or carbonate source. In another preferred embodiment, the dough is formed from the liquid and the dry component, wherein the liquid comprises water and the dry component comprises a sulfur protein source, a carbohydrate source, the monovalent cationic bicarbonate or carbonate source, and a reducing agent.

The dough is heated to a temperature of about 100-150° C., and provided as a heated dough to an entry orifice of a cooling device. In certain embodiments, the cooling device is a cooling die. The heated dough can be transferred to the cooling device, for example, with a low shear pump or by hand.

In a preferred method, the dry component and liquid can be mixed and heated within a pressurized heated process device to provide the heated dough to the cooling device. As noted above, a plurality of dry components can be added to the process simultaneously via separate feeds, simultaneously as a dry component, or sequentially from the same or separate feeds.

Suitable pressurized heated process devices include, but are not limited to, a piston pump, a twin-screw extruder, a single-screw extruder, an extrusion mill, a kneading extruder, or any device familiar to those skilled in the art for the preparation of texturized vegetable protein. In a preferred embodiment, the pressurized heated process device is a single screw extruder. In such cases, the dough can be formed within the pressurized heated process device by providing the dry component and liquid thereto.

The heated dough can be provided to the cooling device at a pressure ranging from about 50-900 psi and a temperature of about 100-150° C. In other embodiments, the heated dough is provided to the cooling device at a pressure ranging from about 50-500 psi, 50-300 psi, or 100-250 psi. In combination with any of the preceding pressures, the heated dough can be provided to the entry orifice of the cooling device at a temperature of about 100-140° C., or 105-135° C., or 110-130° C.

The heated dough is conveyed through the cooling device at a pressure ranging from 50-900 psi to an exit orifice of the cooling device to yield the meat analog product, wherein the meat analog product has a temperature, at the exit orifice of the cooling device, of 130° C. or less, and preferably 100° C. or less. The meat analog products produced by the methods of the present invention generally comprise a plurality of striated and separable aligned fibers.

In general, there is no limitation in the present method on the length, shape, and dimension of the cooling device; however, it should provide sufficient heat transfer to cool the dough to the correct consistency. The cooling rate should be fast enough so the center of the dough is not in a liquid state, but should not be so fast that the outside is excessively cooled, so that the aligned fibers are not ruptured by the dynamic pressure of the flow. Cooling too fast can create a plug flow, which will break the dough as it dragged along the device. It is preferred that a cooling device which, in conjunction with the rate at which the dough passes through the device, provides a meat analog product extruded from one or more orifices of the cooling device at an product temperature of about 20-100° C., 50-100° C., or 75-100° C. As is familiar to those skilled in the art, the temperature at which the meat analog product is provided to the exit orifice of the cooling device depends on factors such as the dimensions of the cooling device and the rate at which the meat analog product is conveyed through the cooling device. Such factors can be adjusted by one skilled in the art such that the meat analog product is provided to the exit orifice at the proper temperature (supra).

For example, when the dough is prepared and heated within a pressurized heated process device and provided to the cooling device, the total forming time of the meat analog product from entry of the dry component(s) and liquid into the pressurized heated process device to the exit orifice of the cooling device can be about 1-5 minutes; preferably, the forming time is about 1-2 minutes.

The meat analog product, as it exits the cooling device, can have the characteristics of flowable, plastic, cohesive dough, and can be sticky due to the addition of the carbohydrate source. Upon cooling to ambient temperature, the resultant meat analog product consists of striated, separable aligned fibers of protein closely resembling the structure of whole meats. The color and texture are also highly similar to naturally-occurring whole meats.

The pH of the meat analog product is typically about 6.0-7.8; preferably, the pH is about 6.5-7.5; most preferably, the pH is about 6.8-7.2. The meat analog product produced according to the preceding process can have about 25-60% protein, by weight. Preferably, the product has about 25-40% protein, by weight. More preferably, the product has about 26-31% protein, by weight. In certain embodiments, all of the protein in the meat analog product is from the dry component (e.g., the dough is formed from only the dry component, a liquid, and the monovalent cationic bicarbonate or carbonate source, where the liquid does not contain any protein).

The product can have about 0.2-20%, preferably about 1.5-10% fat by weight; more preferably, about 2-5% fat by weight. Further, the meat analog product can have a moisture content of 25-65%, by weight; preferably about 40-50% by weight; and more preferably about 43-45% by weight. The water activity of the product can be about 0.89-0.96, and in various embodiments, can range from about 0.90-0.92.

The meat analog produced by the above methods can be further processed by dicing or cutting to a desired size. Additional palatants or flavorings such as meat flavoring and fillers such as those made from cereals can be added and the final product can be packaged and retorted to create a commercial product. For example, the meat analog product can be folded and/or crinkled to create an irregular look on the outside. Ultimately, a formed meat analog product can be chopped in an Urschel (type) dicer into any of a variety of shapes, including chunks. The product can also be, for example, dried, retorted, or fried according to methods familiar to those skilled in the art to yield a shelf-stable product.

### EXAMPLES

The Examples which follow are illustrative of specific embodiments of the invention, and various uses thereof. They are set forth for explanatory purposes only, and are not to be taken as limiting the invention.

### Example 1

### Meat Analog Preparation Method

Each of the required dry raw materials were weighed according to the recipe in Example 2 or 3, mixed in a powder blender for about 10 minutes to generate the “dry component”. Dry component was placed into a hopper of the dosing equipment. Each required liquid was weighed according to recipe and mixed by high shear mixer such as Silverson mixer.

A single screw extruder is the most preferred equipment to process the meat analog. Its screw configuration was set to provide low shear to the dough and its barrels temperature profile were set to optimum heat transfer to the dough.

Both the dry component and liquids were injected into an extruder where the mixing process to form a dough occurs through rotation of the screws and at the same time cooking process start taking in place through thermal energy absorbed by dough from the extruder barrel wall.

The cooked dough reached a temperature above 120° C. and it was forced through an orifice of a cooling die. The dough was cooled down to temperature below 100° C. and set down to a stable striated meat analog chunk.

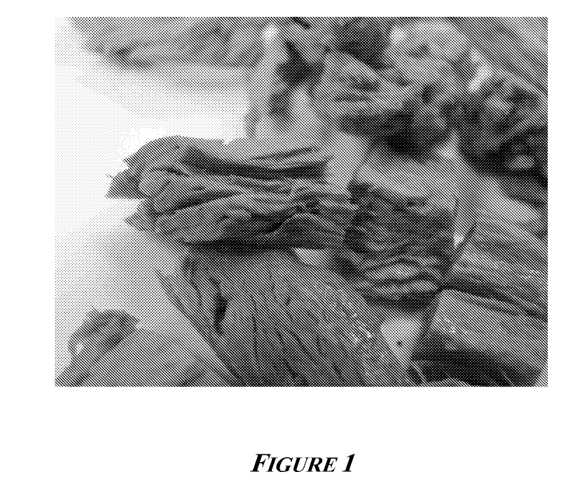

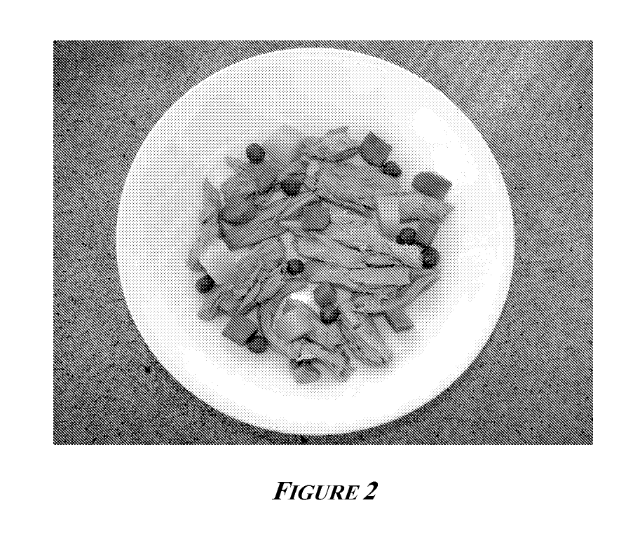

The formed meat analog was further processed through a dicer (as shown in FIG. 1) and shredder (as illustrated by FIG. 2) to get the final size and appearance which can be incorporated to gravy and other ingredients to get the finished product.

### Example 2

After the basic recipe was achieved, a further investigation trial has been conducted to determine advantageous ranges of raw materials satisfactory in both the amounts in the recipe and in type that can result in a meat analog product according to the invention.

The table below show the range tested that produced acceptable meat analog.

DRY COMPONENT MIXTURE

| Raw material | Min(%) | Avg(%) | Max(%) |
|---|---|---|---|
| Wheat Gluten | 30 | 61 | 85 |
| Chicken Meal | 0 | 8 | 40 |
| Spray Dried Chicken | 0 | 7.5 | 40 |
| Corn Flour | 0 | 13.9 | 30 |
| Rice Flour | 0 | 1.8 | 30 |
| Sodium Bicarbonate | 0.3 | 1.2 | 3.6 |
| Dicalcium Phosphate | 0 | 3.6 | 10.8 |
| Salt | 0 | 2.5 | 5 |
| Soy Concentrate | 0 | 0.5 | 2 |

TOTAL

| | | | |
|---|---|---|---|
| Dry component | 63 | 49.4 | 40 |
| Water | 37 | 43 | 50 |
| Oil in Water emulsion | 0 | 7.6 | 10 |

### Example 3

In alternative embodiments, a recipe of the invention comprises:

DRY COMPONENT MIXTURE

| Raw material | Min(%) | Avg(%) | Max(%) |
|---|---|---|---|
| Wheat Gluten | 30 | 61 | 85 |
| Chicken Meal | 0 | 8 | 40 |
| Spray Dried Chicken | 0 | 7.5 | 40 |
| Corn Flour | 0 | 13.9 | 30 |
| Rice Flour | 0 | 1.8 | 30 |
| Sodium Bicarbonate | 0.3 | 1.2 | 3.6 |
| Dicalcium Phosphate | 0 | 3.6 | 10.8 |
| Salt | 0 | 2.5 | 5 |
| Soy Concentrate | 0 | 0.5 | 2 |
| Inactivated yeast | 0 | 1.5 | 3.0 |

TOTAL

| | | | |
|---|---|---|---|
| Dry component | 63 | 49.4 | 40 |
| Water | 37 | 43 | 50 |
| Oil in Water emulsion | 0 | 7.6 | 10 |

### Example 4

In another set of trials, a preferred recipe, such as Examples 2 and 3, was tested in a twin extruder which produced a meat analog of the invention. Again, a low shear screw configuration and thermal energy transfer from the extruder barrel were the necessary conditions to form the meat analog. The table below shows the range of extrusion parameters that produced meat analog.

| Parameters | Range (° C.) |
|---|---|
| Barrel 1 | 0-50 |
| Barrel 2 | 20-100 |
| Barrel 3 | 20-100 |
| Barrel 4 | 50-150 |
| Barrel 5 | 50-150 |
| Barrel 6 | 50-150 |
| Barrel 7 | 50-150 |
| Final meat analog | <100 |

### Example 5

The method for preparing the meat analog product of the present invention according to Example 1 was repeated using the recipe of Example 2 with the following changes or substitutions.

| Sodium | Dicalcium | | |
|---|---|---|---|
| Bicarbonate (wt %) | Phosphate (wt %) | pH | Product formation? |
| 1.2 | 3.6 | 7.2 | Yes |
| 0.6 | 1.8 | 6.8 | Yes |
| 2.4 | 7.2 | 7.1 | Yes |
| 0 | 0 | 6.4 | No |
| 4.8 | 0 | 7.7 | Yes |
| 0 | 4.8 | 6.3 | No |

| Sodium Bicarbonate substitute | Product formation? |
|---|---|
| Sodium carbonate | Yes |
| Ammonium bicarbonate | Yes |
| Potassium bicarbonate | Yes |
| Ammonium carbonate | Yes |
| Potassium carbonate | Yes |

As can be seeing from the proceeding, the methods of Example 1 successfully yield a meat analog product of the invention when a monovalent cationic carbonate or bicarbonate is utilized in the recipe of Example 2. However, alternate salts of monovalent cationic species (i.e., nitrate, bisulfate) were not successful; nor were dicationic carbonates such as magnesium and calcium carbonate.

Although the invention has been described in detail with particular reference to a preferred embodiment, other embodiments can achieve the same results. Variations and modifications of the present invention will be obvious to those skilled in the art and it is intended to cover in the appended claims all such modifications and equivalents.

We claim:

1. A meat analog product comprising a combination of a dry component, a liquid, and a monovalent cationic carbonate or bicarbonate source, wherein the dry component, having a protein content, comprises a dry sulfur protein source; the liquid comprises water; and the meat analog product comprises a plurality of striated and separable aligned fibers throughout the product.

2. The meat analog product of claim 1, further comprising a reducing agent.

3. The meat analog product of claim 1, further comprising a leavening acid.

4. The meat analog product of claim 3, wherein the monovalent cationic carbonate or bicarbonate source and leavening acid are present in a ratio of about 1:2-1:4 by weight.

5. The meat analog product of claim 1, wherein the dry component comprises 0.4-4.8 wt % of the monovalent cationic carbonate or bicarbonate source, based on the total weight of the dry component.

6. The meat analog product of claim 1, wherein the dry sulfur protein source comprises a gluten, a soy protein, a pea protein, an egg protein, or a mixture thereof.

7. The meat analog product of claim 1, wherein the dry component comprises a dry meat sulfur protein source or a dry protein or fiber source derived from a whole grain, a fruit, a vegetable, or mixtures thereof.

8. The meat analog product of claim 1, wherein the liquid further comprises a fresh or frozen meat source, a rendered meat source, or mixtures thereof.

9. The meat analog product of claim 1, wherein the liquid, the dry component or both further comprise one or more humectant, fat source, coloring agent, palatant, flavoring, vitamin, mineral, antioxidant, dried blood plasma, salt, dextrose, sorbitol, starch, soy proteins, gelatin, nitrates, phosphates, or fiber source.

10. The meat analog product of claim 1, wherein about 30-80 wt. % of the protein content of the dry component is from the dry sulfur protein source.

11. The meat analog product of claim 1, wherein the dry component further comprises a dry carbohydrate source, wherein the dry carbohydrate source comprises corn flour, corn meal, pea fibers, a starch, or mixtures thereof.

12. The meat analog product of claim 1, wherein the meat analog product comprises about 25-60% total protein by weight.

13. The meat analog product of claim 1, wherein the meat analog product has a pH of about 6.0-7.8.

14. The meat analog product of claim 1, wherein the meat analog product comprises a fat content of 0.2-20% by weight.

15. The meat analog product of claim 1, wherein the meat analog product comprises about 25-65% moisture by weight.

16. A method for preparing a meat analog product, the method comprising:
a) combining a monovalent cationic bicarbonate or carbonate source, water, and a dry component comprising a sulfur protein source under low shear mixing conditions to form a dough;
b) heating the dough to a temperature of about 100-150° C. to yield a heated dough;
c) providing the heated dough to an entry orifice of a cooling device;
d) conveying the heated dough through the cooling device under a pressure of 50-900 psi to an exit orifice of the cooling device, to yield a meat analog product, wherein the meat analog product has a processing temperature of 100° C. or less at the exit orifice.

17. The method of claim 16, wherein the dough further comprises a reducing agent.

18. The method of claim 16, wherein the meat analog product comprises a plurality of striated and separable aligned fibers.

19. The method of claim 16, wherein the heated dough is formed and heated in a pressurized heated process device.

20. The method of claim 19, wherein the pressurized heated process device is a piston pump, a twin-screw extruder, a single-screw extruder, an extrusion mill, or a kneading extruder.

21. The method of claim 20, wherein the pressurized heated process device is a single-screw extruder; and the dough is formed within the pressurized heated process device by providing the liquid and the dry component to the pressurized heated process device.

22. A meat analog product prepared according to the method of claim 16.
